(19) United States
(12) Patent Application Publication
(10) Pub. No.: US 2010/0275784 A1
(43) Pub. Date: Nov. 4, 2010

(54) SYSTEM AND METHOD FOR REGULATING ENVIRONMENTAL PARAMETERS AND LOSSES IN PREMISES FOR AGING AND PRESERVING WINE

(75) Inventor: Francisco Javier Cumplido Matesanz, Logrono (ES)

Correspondence Address: KNOBBE MARTENS OLSON & BEAR LLP, 2040 MAIN STREET, FOURTEENTH FLOOR, IRVINE, CA, 92614, US

(73) Assignee: TECNICA EN INSTALACIONES DE FLUIDOS, S.L., Logrono (ES)

(21) Appl. No.: 12/770,564

(22) Filed: Apr. 29, 2010

(30) Foreign Application Priority Data
Apr. 29, 2009 (ES) P200930113

(51) Int. Cl. C12H 1/22; F25B 15/00; F24F 3/14

(52) U.S. Cl. 99/277.1; 62/271; 165/222

(57) ABSTRACT

The invention relates to a system and method for regulating environmental parameters and losses in premises for aging and preserving wine comprising an air treatment unit (3) connected to a cold energy source (7) and to a heat energy source (8), a control module (9) configured to regulate the losses of wine occurring in the casks (2) of the premises (1), acting on environmental parameters of the premises (1), such as temperature, relative humidity, speed of the air and generation of molds, without affecting the quality of the stored wine, while at the same time controlling and maintaining the environmental quality in the premises (1).

### CROSS-REFERENCE TO RELATED APPLICATIONS

The present application claims the benefit under 35 U.S.C. 119(a)-(d) of Spanish Patent Application No. P200930113, filed on Apr. 29, 2009, the entire contents of which are incorporated herein by reference.

1. Technical Field of the Invention

The application of the present invention is in the sector of heat facilities and controlling processes, and more specifically in controlling losses in premises for aging and preserving wine and spirits, which allows regulating environmental parameters of the premises, such as temperature, humidity, speed and degree of renewal of the air as well as the degree of generation of molds, for the purpose of regulating and adjusting to random values the percentage of loss which naturally occurs inside vessels containing wine made from wood, such as vats, kegs, barrels or casks. At the same time the percentage of losses is maintained within determined values, the quality of the stored wine is maintained and the environmental quality is improved by controlling mold populations existing in the environment of the premises.

2. Background of the Invention

Aging wine in an oxidation-reducing medium in oak casks is a technique which improves the quality of wines and is widely used in the wine industry. A series of interactions occurs between the wine, the wood and the environment of the premises in which said wine is located during the aging period of the wine. One of the most significant consequences of these interactions from a quantitative point of view is the transfer of part of the wine mass from inside the casks to the environment through the oak staves forming the casks, which is known as loss of wine.

These losses are increasingly more representative for several factors, among which, on one hand, it is necessary to point out the increased aged wine storage capacity in wine cellars today, which involves an increase of the total number of casks and, on the other hand, the current tendency to build above-ground or semi-underground storage areas for aging to the detriment of underground storage areas, a fact that even further alters the natural environmental conditions of temperature and relative humidity inside this type of premises.

The problem of the losses occurring in the premises for casks intended for aging and preserving wine has been approached on many occasions, currently resorting to conditioning or treating the air in the storage areas for aging as a means of controlling the losses of the wine.

U.S. patent application US-2008179413-A1 describes a cooling facility configured to control the temperature and the humidity of a wine storage premises. The temperature is controlled by means of a sensor installed in the premises, whereas the humidity is controlled by means of the evaporation of water located in the condensate drip tray of the evaporator that cools the premises.

Likewise, U.S. Pat. No. 6,755,118-B1 describes a facility which allows controlling the temperature and humidity of a cask storage area by means of using a network of buried conduits in which external air is cooled while at the same time a fan located in the upper part of the storage area allows moving the air, both the air circulating inside the buried conduits and the air circulating in the actual premises.

On the other hand, Japanese patent application number JP-2001112462-A describes a system for controlling temperature and humidity in wine storage premises which comprises mixing sprayed cold water with air from the actual premises, such that the air acquires a higher degree of humidity and is subsequently heated. According to the system described in this Japanese patent application, the temperature and humidity parameters are controlled depending on the temperature of the cold water and of the heated air.

In the same manner, French patent number FR-2783041-B1 describes an air conditioning system by controlling the temperature, the humidity and the degree of environmental air renewal, whereas other patent registrations, such as Japanese patent application number JP-2002154608-A or French patent number FR-2847968-B1, also describe systems for controlling the ambient humidity and temperature in storage areas for aging and preserving intended for housing wine casks.

On the other hand, French patent number FR-2701485-B3 describes an apparatus for the individual control of the temperature, relative humidity and speed of the air in each wine cask, which can be controlled in a centralized manner. However, the main drawback of said system is that it requires providing each cask with a metal structure, which involves very high costs, while at the same time it makes it difficult to perform routine operations carried out in the storage area for aging and conserving wine. On the other hand, this system does not assure good sanitary condition of the wine either, or a determined percentage of losses occurring in the wine.

Therefore, the current solutions are based on controlling determined environmental parameters in the premises intended for storing and preserving wine, mainly the temperature, speed, humidity and, occasionally, renewal, of the air. Even though they control humidity, it is not the only factor that affects the molds of the environment. It is not even the most determining factor.

However, said solutions or techniques neither consider nor act on aspects relating to controlling molds in the environment of the premises or to obtaining a determined percentage of losses in the wine, without affecting the quality thereof. The current state of the art therefore acts on the environmental conditions of a cask storage area, but it does not act on maintaining the percentage of losses within a determined range, or on controlling the existing environmental molds. Controlling these parameters affects the environment of the establishment, but a percentage of losses in the wine can neither be measured nor assured. In fact, these solutions or techniques do not relate to losses or to controlling molds.

For this reason said systems lack suitable control over all those parameters, as well as the interrelation thereof, which affect the losses of wine during the aging and storage thereof and they do not assure the sanitary conditions thereof. There is an interrelation between environmental parameters affecting losses and molds, but this interrelation has not been explained. This specification indicates that it can be known and controlled.

### DESCRIPTION OF THE INVENTION

A first aspect of the present invention relates to a system for regulating environmental parameters and losses of wine in premises for aging and preserving wine, which allows solving the problems existing in the cask storage areas existing today for preserving and maintaining wine, in which an exchange of matter between the wine and the environment occurs.

As indicated above, the systems used today for treating the environment of the storage areas for aging and preserving wine in casks are, for the most part, systems for conditioning and controlling the environmental conditions. These systems act only on the temperature, humidity and degree of renewal of the air, but they do not relate these parameters with the percentages of losses occurring in the wines stored, or with the proliferation of molds in the environment, or the quality of the air through its composition and the elements present therein.

Furthermore, it can be asserted that the parameter of the speed of the environmental air is extremely important for controlling the percentage of losses occurring in the stored wine, an aspect which is also controlled by the system object of the present invention. Likewise, a suitable level of environmental quality, as well as energy savings in the facility, are very important. All these aspects are achieved with the system object of the present invention.

The system allows assuring a predetermined percentage of losses, because upon performing a complete control over all the variables described, it can act on them with the necessary certainty and speed.

The system for regulating environmental parameters and losses in premises for aging and preserving wine proposed by the invention comprises at least one air treatment unit configured to condition and mix air contained in a storage premises, which can be an establishment, storage area or wine cellar configured to contain at least one wood cask, typically a plurality of casks or any other equivalent wine or spirit container.

Said air treatment unit comprises means for driving air and means for absorbing or returning air of the premises, being able to consist of a network of conduits, gratings and gates operatively connected and arranged in the premises, both networks being in charge of leading the air to or from the air treatment unit.

The system also comprises at least one sensor, preferably a plurality of sensors operatively distributed in the premises, configured to measure environmental parameters, including temperature, relative humidity, degree of renewal, speed and composition of the air and percentage of molds existing in the environment, in the premises, in which said at least one sensor is operatively connected to a control module configured to act on each air treatment unit, being operatively connected to each air treatment unit.

The control module is also configured to automatically regulate each environmental parameter, the percentage of losses of wine in each cask of the premises and the percentage of molds existing in the environment of the premises, thus achieving an automatic increase or reduction in the percentage of losses occurring while aging and preserving wine stored in casks, achieving a pre-established percentage of losses.

The system comprises at least one cold energy production source and at least one heat energy production source each of which is operatively connected with the control module and each air treatment unit. In other words, each air treatment unit is operatively connected with a cold energy source and a heat energy source, which are in charge of producing cold or hot fluid, respectively, serving as a means for heat exchange with the environmental air that is to be treated in the premises. It is achieved by means of controlling the mean annual rate of passage of wine to the environment through the walls of the casks or containers.

The system of the invention is easy to install and does not cause any problems for the normal activity of a wine cellar, allowing suitable control over the environmental parameters affecting the percentage of losses occurring in the wine stored in wood containers, such as casks, to be able to control and regulate, even eliminating if desired, the percentage of losses, which allows selecting a determined or arbitrary percentage of losses, all this without jeopardizing the quality of the stored wine.

The present invention allows its adaptation to the conditions for aging and preserving the wine of each premises, i.e., of each wine cellar, depending on the characteristics of the wine to be obtained, or where appropriate, of the spirit to be obtained, all by means of performing suitable control and regulation of the environmental parameters affecting the losses of wine, which allows working in the ranges necessary for assuring the desired percentage of losses, maintaining the quality and characteristics of the stored wine and preventing the uncontrolled proliferation of molds which could affect the wine in the long term.

This system is therefore capable of controlling and regulating the amount and quality of the molds, as well as the percentage of wine that is lost over the year, in a predetermined manner due to the characteristics of its equipment and to the automatic control it incorporates by acting on all the variables, prioritizing those variables necessary for achieving a desired percentage of losses, whereas the remaining variables adapt to the programming, always based on the conditions of the existing external air.

The system for regulating environmental parameters and losses in premises for aging and preserving wine of the invention is configured to determine the volatile compounds, such as CO₂ and CH₃-CH₂OH for example, which may exist in the internal environment of the premises. The system of the invention is based on determining, knowing and optimizing the aforementioned environmental parameters of the premises, such as the optimal work area at all times, as well as the interdependence between said environmental parameters.

The control module is configured to supply the premises with air in conditions of temperature, preferably maintaining it in a range between 12 and 25° C., relative humidity, preferably maintaining it between 50% and 95%, suitable percentage of renewal and speed of the air, for the purpose of maintaining it within optimal and pre-established conditions, maintaining all the parameters affecting the percentage of losses and the environmental quality in optimal values, creating an interdependence between them, for which purpose it is necessary to fix some parameters while at the same time others vary. The control module is also capable of establishing the quality required in the premises at all times, assessing all the variables and optimizing them, always taking into account the desired quality in the air, the pre-established percentage of losses and the possible energy savings, not allowing the use of combinations of variables which, even when they do control determined environmental parameters (temperature, humidity . . . , or both), create conditions in which neither the percentage of losses occurring in the wine nor the populations of molds existing in the environment of the establishment can be controlled.

The system has a cost-effective operation, achieving an energy savings for which the maximum possible amount of free energy is used either by making use of the external conditions or by means of the energy of the process itself. It has a system which minimizes the amount of external air at all times when the conditions thereof involve an energy expenditure which exceeds that which is programmed.

The control system is based on prioritizing or fixing at all times a desired parameter of those mentioned above, readapting the remaining parameters to a specific value according to the value of said fixed parameter, i.e., depending on a certain parameter which is considered as independent, which can also vary, the remaining parameters affecting the percentage of losses and the environmental quality of the air of the cask storage area are automatically adjusted.

Having control over the different variables which come into play, as well as over the compounds existing in the environment, allows the system to also control the generation of molds inside the cask storage area, maintaining suitable quality in the environment of the cask storage area.

The regulation of the losses is achieved by controlling the mean annual rate of passage of wine to the environment through the wood of the cask.

A second aspect of the invention relates to a method for regulating environmental parameters and losses in premises for aging and preserving wine comprising the following steps:

prioritizing or adjusting the rate of passage of wine to the environment, and

adjusting the variables affecting said rate of passage (temperature, humidity, speed of the air, degree of renewal) depending on the external temperature, in order to thus achieve a pre-established percentage of losses, quality and control over the environmental molds, all with the minimal energy supplied.

Therefore, according to the described invention, the system proposed by the invention constitutes an advance in the systems used up until now, and solves in a fully satisfactory manner the drawbacks described above, maintaining the organoleptic quality of the wine being preserved and aged, which is a fundamental objective of any cask storage area, while at the same time achieving a savings in the lost amount of wine, accurately controlling said loss.

### DESCRIPTION OF THE DRAWINGS

To complement the description that is being made and for the purpose of aiding to better understand the features of the invention according to a preferred practical embodiment thereof, a drawing is attached as an integral part of said description which depicts in an illustrative and non-limiting manner a schematic elevational view of the interior of a premises for aging and preserving wine with the system for regulating environmental parameters and losses proposed by the invention, schematically showing a plurality of wood casks containing wine in a stacking position and supported by metal structures or sills, as well as the operating principle of the method for regulating environmental parameters and losses of the invention.

### PREFERRED EMBODIMENT OF THE INVENTION

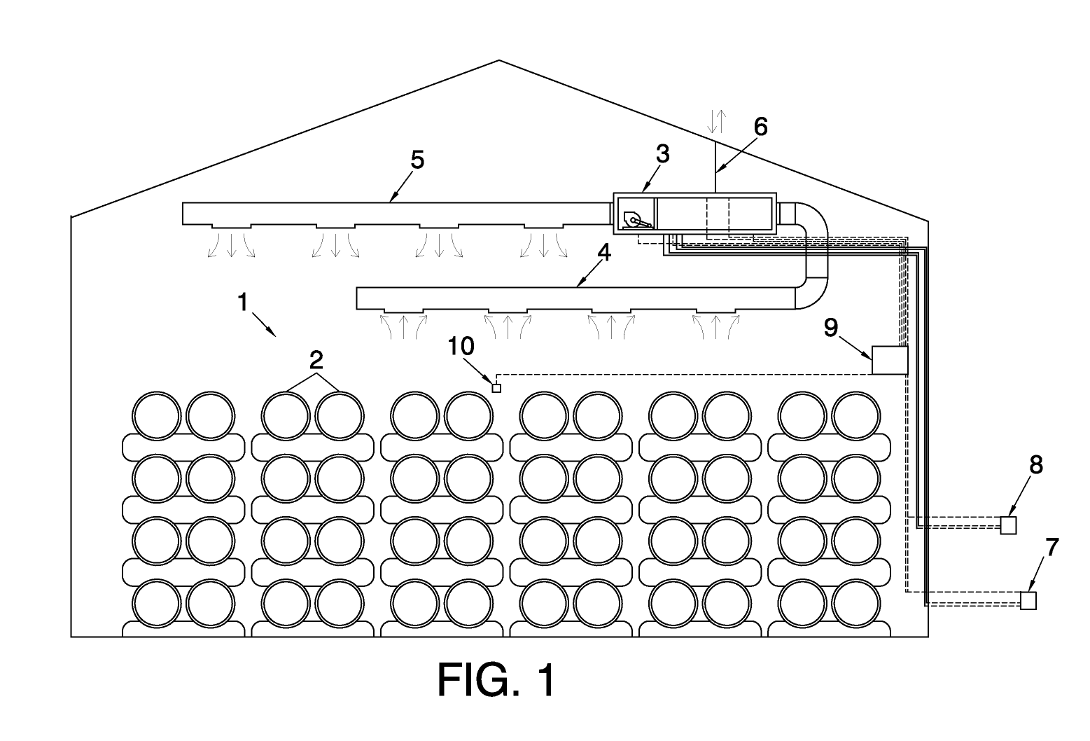

In view of the figures discussed, it can be observed how, in one of the possible embodiments of the invention, the system for regulating environmental parameters and losses in premises for aging and preserving wine proposed by the invention comprises an air treatment unit (3) in charge of moving and treating the environmental air of the premises (1). Said air treatment unit (3) has a particular construction in terms of its materials and morphology. Basically, it is morphologically described in FIG. 1. In terms of materials, it will be built with materials having a redeemable service life in a wine cellar (PVC, stainless steel, steel, etc).

FIG. 1 shows a diagram of the operating principle of the system of the invention, showing a premises (1), intended for storing and/or aging wine in wood casks (2), which are stacked on top of one another on metal structures or sills.

A network of means (4) for absorbing air is in charge of leading the air to be treated towards the air treatment unit (3). Once treated, the air is again sent to the premises (1) as a result of a network of means (5) for driving air.

To assure suitable air renewal as well as a cost-effective operation of the system, it has means (6) for renewing air, which can consist of a shaft or equivalent natural ventilation means. Said means (6) for renewing air produce a renewal only when it is necessary, in the necessary percentage at all times.

The system comprises a control module (9) which uses all the free energy possible which comes from the exterior as well as from the process itself, which contributes to a considerable energy savings of the facility, always without jeopardizing the quality of the air and wine existing in the premises (1).

The system also comprises a cold energy source (7) and a heat energy source (8), which feed the air treatment unit (3).

The control module (9) acts on the flow moved by the treatment unit (3), on the supply and production of cold and heat energy and on the means (6) for renewing air. The control module (9) is also operatively connected to a network of sensors (10) located at strategic points of the premises (1), to be able to send to the internal environment air in suitable conditions of temperature, relative humidity, percentage of renewal, quality and speed. This control system is formed by the equipment (automatons, software . . . ) necessary to perform all the described controls. The environmental parameters are also controlled so that they have values that can coincide (e.g. a determined temperature, with a determined humidity, a suitable degree of renewal, with a determined speed of the air), avoiding values the coincidence of which is unwanted. These combinations or prohibited or unwanted work areas have been determined experimentally.

The control module (9) acts as follows. By considering an environmental parameter affecting the percentage of losses and environmental quality, such as temperature, relative humidity, percentage of renewal, quality or speed of the air, to be fixed, the module acts automatically on the values of the remaining parameters that are not fixed, readjusting them to suitable values. Thus, there is continuous interdependence between all the parameters affecting said losses and environmental qualities, thus being able to control both aspects.

The system considers a determined premises (1) or storage area intended for storing and preserving wine in wood casks (2), in which an exchange of mass occurs spontaneously through capillarity between the wine inside the casks (2) and the environmental air due to the environmental conditions existing in said premises (1).

To achieve control in this percentage of losses occurring in the wine, the environmental parameters existing in the air of the premises (1), as well as the previously described components, are acted on.

To that end, the system comprises an air treatment unit (3), which is made up of a fan, a system for the addition or loss of heat, the addition or loss of cold, as well as the addition or loss of humidity.

The control module (9) of the system is also configured to assure a cost-effective operation of the system, when the external conditions allow it and when it is necessary, allowing the use of fee energy coming from the external environment and from the process itself, whenever possible, this aspect contributing to a considerable energy savings.

The control module (9) acts on the cold energy source (7) and heat energy source (8), respectively, on the air inlet and outlet gates, on the supply of cold or hot fluid, receiving information from the environment as a result of the network of sensors (10) suitably arranged in the premises (1). The control module (9) furthermore acts on temperature, relative humidity, degree of renewal and speed of circulation of the treated air, for the purpose of controlling the percentage of losses of the wine.

When performing control on the aforementioned environmental parameters and on the components of the environmental air, the generation of molds, which affects the quality and amount of molds existing in the premises (1), is thereby controlled.

There are drive gratings in the network of means (5) for driving air for the correct diffusion of the air to the environment of the premises (1). The amount and quality of the molds existing in the cask storage area, as well as the percentage of losses occurring in the stored wine, can thus be controlled, achieving a reduction or an increase thereof, whichever is desired by the user.

The system object of present invention is based on knowing, from all the aforementioned environmental parameters, which is the optimal work area at all times, as well as the interdependence between them. These data can be known and optimized by the system of the invention. To that end, the patented control system (9) considers some parameters marked at all times to be fixed or priorities, and acts automatically on the remaining parameters in order to adjust them to values within the optimal work area of the system.

According to a preferred embodiment of the invention, the system maintains a set point temperature in a premises (1) with casks (2) in a range of 15-17° C., considering a maximum percentage of losses around 1.5%. To that end, the control module (9) regulates the remaining parameters affecting said percentage of losses, these being relative humidity, ranging between 70% and 85%, and the speed of the air, between 0-5 m/s. The quality of the air is furthermore contrasted in terms of the degree of renewal and composition thereof, so that this quality is the most suitable as possible in these conditions. All these parameters will be automatically readjusted.

In view of this description and set of drawings, the person skilled in the art will understand that the embodiments of the invention that have been described can be combined in many ways within the object of the invention. The invention has been described according to several preferred embodiments thereof, but for the person skilled in the art it will be obvious that many variations can be introduced in said preferred embodiments without exceeding the object of the claimed invention.

1. A system for regulating environmental parameters and losses in premises for aging and preserving wine, characterized in that it comprises:
at least one air treatment unit configured to condition and mix air contained in a premises configured to contain at least one wood cask containing wine or spirit, in which said at least one air treatment unit comprises means for driving air and means for absorbing air of the premises,
at least one sensor configured to measure environmental parameters, including temperature, relative humidity, degree of renewal, speed and composition of the air and percentage of mold existing in the environment, in the premises, in which said at least one sensor is operatively connected to
a control module configured to act on said at least one air treatment unit and regulate each environmental parameter, the percentage of losses of wine in each cask of the premises and the percentage of mold existing in the environment of the premises, and
at least one cold energy source and at least one heat energy source operatively connected with the control module and said at least one air treatment unit.

2. A method for regulating environmental parameters and losses in premises for aging and preserving wine, characterized in that it comprises the following steps:
prioritizing or adjusting the rate of passage of wine to the environment, and
adjusting the variables affecting said rate of passage, temperature, humidity, speed of the air, degree of renewal, depending on the external temperature, in order to thus achieve a pre-established percentage of losses, quality and control over the environmental molds, all with the minimal energy supplied.
